(19) United States
(12) Patent Application Publication
(10) Pub. No.: US 2014/0033292 A1
(43) Pub. Date: Jan. 30, 2014

(54) System and Method for Authenticating Suspect Devices

(71) Applicants: Cary Edward Moore, Webster, TX (US); Gary Robert Rose, Charlotte, NC (US)

(72) Inventors: Cary Edward Moore, Webster, TX (US); Gary Robert Rose, Charlotte, NC (US)

(73) Assignee: Bank of America Corporation, Charlotte, NC (US)

(21) Appl. No.: 13/561,400

(22) Filed: Jul. 30, 2012

(51) Int. Cl. G06F 21/00

(52) U.S. Cl. 726/9

(57) ABSTRACT

In one embodiment, a system includes a memory and a processor communicatively coupled to the memory. The processor is operable to receive a first notification and determine whether the first device is associated with the user account. The processor is also operable to communicate a token to the first device in response to determining that the first device is associated with the user account. Additionally, the processor is operable to receive a second notification comprising a request to authenticate the user. The processor may also determine if the second notification comprises the token. The processor is operable to authenticate the user if the second notification comprises the token. The processor is also operable to authenticate the user if the second device is not associated with the user account and the second notification comprises user credentials associated with the user account.

### TECHNICAL FIELD OF THE INVENTION

This invention relates generally to user authentication and, more specifically, to an authentication system and method for authenticating suspect devices.

### BACKGROUND OF THE INVENTION

Enterprises handle a large number of customer transactions on a daily basis. New methods of conducting transactions become available as technology advances. For some customers, it may be desirable to conduct transactions using one of a variety of devices, such as a smart phone or tablet device. However, a customer may not wish to enter all of the personal authentication information required to access a particular service via a suspect device.

### SUMMARY OF THE INVENTION

According to embodiments of the present disclosure, disadvantages, and problems associated with previous authentication systems may be reduced or eliminated.

In certain embodiments, a system may include a memory and a processor communicatively coupled to the memory. The memory is operable to store a user account associated with a user. The processor is operable to receive a first notification associated with a first device and determine whether the first device is associated with the user account. The processor is also operable to communicate a token to the first device in response to determining that the first device is associated with the user account. Additionally, the processor is further operable to receive a second notification associated with a second device, the second notification comprising a request to authenticate the user, wherein the user is attempting to access a service using a network. The processor may also determine an expiration threshold associated with the token, determine time information associated with the second notification, determine if the second notification comprises the token, and determine if the second notification comprises a verifier. Furthermore, the processor is operable to authenticate the user if: the time information does not exceed the expiration threshold, the second notification comprises the token, and the verifier is associated with the user account. The processor is also operable to authenticate the user if the second device is not associated with the user account and the second notification comprises user credentials associated with the user account.

Particular embodiments of the present disclosure may provide some, none, or all of the following technical advantages. For example, security may be increased for a user because the user will not have to enter private user credentials into a public, unfamiliar, or otherwise suspect device. Through the use of a temporary authentication token, the user can ensure that a malicious party may not gain access to the user's private user credentials. Another advantage is added convenience to the user. By using a trusted device to request a temporary authentication token, the user will not have to remember the user's user credentials each time the user wants to access a service via a suspect device. Security is further enhanced by allowing the user to quickly obtain a temporary authentication token instead of perhaps memorializing user credentials on a physical item such as paper which may be lost or discarded and may be discovered by a third party, thereby conserving the computational resources and bandwidth consumed by processing user credential reset requests or any other action associated with user credential misplacement and/or misappropriation.

In certain embodiments, a user may be authenticated using a temporary authentication token instead of being required to enter extensive authentication information into a suspect device, thereby conserving the computational resources and bandwidth consumed by processing additional authentication information received from suspect devices.

Certain embodiments of the present disclosure may include some, all, or none of the above advantages. One or more other technical advantages may be readily apparent to those skilled in the art from the figures, descriptions, and claims included herein.

### BRIEF DESCRIPTION OF THE DRAWINGS

For a more complete understanding of the present disclosure and its advantages, reference is made to the following descriptions, taken in conjunction with the accompanying drawings in which:

FIG. 1 illustrates an example suspect device authentication system;

FIG. 2A illustrates example user account data which may be used by the example system of FIG. 1;

FIG. 2B illustrates example trusted device data which may be used by the example system of FIG. 1;

FIG. 2C illustrates example temporary authentication token data which may be used by the example system of FIG. 1; and

FIG. 3 illustrates an example method for authentication, which may be performed by the example system of FIG. 1 to authenticate a user, according to certain embodiments of the present disclosure.

### DETAILED DESCRIPTION OF THE INVENTION

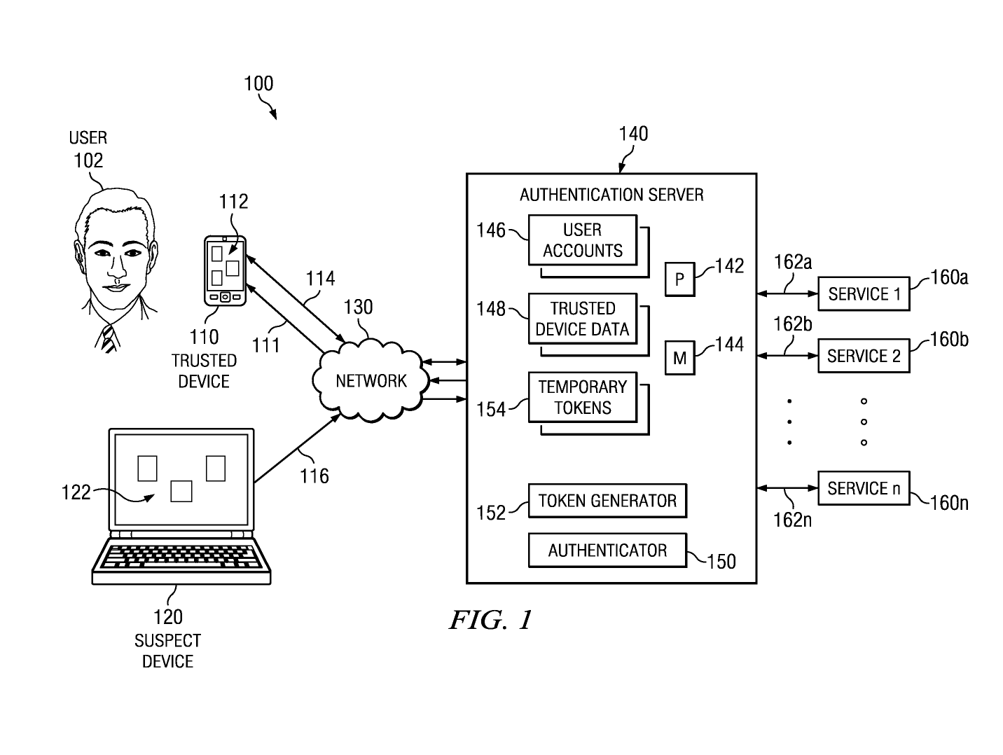

Certain embodiments of the present disclosure provide techniques for authenticating a customer using suspect device authentication. FIGS. 1 through 3 below illustrate systems and methods for authenticating a customer using suspect device authentication.

FIG. 1 illustrates an example suspect device authentication system 100, according to certain embodiments. In general, suspect device authentication is used by enterprises, such as financial institutions, to authenticate a customer's financial transactions using a suspect device, or a device that may not be associated with the customer. Typically, accessing a particular service using a suspect device may require the customer to enter various user credentials into the suspect device for authentication, such as a username and password. Suspect device authentication may allow a customer to use a trusted device to request a temporary authentication token. The customer can then use that temporary authentication token instead of default user credentials to access the particular service on a suspect device. In particular, suspect device authentication system 100 comprises user 102, trusted device 110, suspect device 120, network 130, authentication server 140, and services 160.

In general, user 102 may be any user that intends to use a particular service offered by an enterprise through a device. For example, user 102 may use trusted device 110 or suspect device 120 to access such a particular service. Trusted device 110 may be any device that suspect device authentication system 100 may recognize as associated with user 102. Suspect device 120 may be any device that suspect device authentication system 100 may not recognize as associated with user 102.

In particular, trusted device 110 and/or suspect device 120 may be any device capable of providing functionality to, being operable for a particular purpose, or otherwise used by user 102 to access a particular service. Additionally, trusted device 110 and/or suspect device 120 may be any device operable to communicate with any other trusted device 110, any other suspect device 120, network 130, authentication server 140, services 160, and/or any other component of suspect device authentication system 100 suitable for a particular purpose. For example, trusted device 110 and/or suspect device 120 may be a laptop computer, personal digital assistant (PDA), cellular phone, tablet, portable media player, smart device, smart phone, key fob, or any other device capable of communication. In some embodiments, suspect device 120 may be an automated teller machine. Communication may be accomplished wirelessly or via wireline and may be in the form of an e-mail, SMS text message, an instant message, a packet according to a network protocol, and/or any other suitable message format.

In certain embodiments, trusted device 110 and/or suspect device 120 may include one or more processors, one or more memories, one or more displays, one or more interfaces, one or more components capable of inputting data, one or more components capable of outputting data, one or more components capable of communicating with any other component of suspect device authentication system 100, or any other component suitable for a particular purpose. According to certain embodiments, trusted device 110 and suspect device 120 may each include a device identifier. The device identifier may be a unique identifier that allows suspect device authentication system 100 to differentiate trusted device 110 or suspect device 120 from any other device. For example, trusted device 110 and suspect 120 may each store its respective device identifier as an alphanumeric string in its respective memory.

In some embodiments, trusted device 110 may comprise graphical user interface (GUI) 112 and suspect device 120 may comprise GUI 122. GUIs 112 and 122 are generally operable to tailor and filter data presented to user 102. GUIs 112 and 122 may provide user 102 with an efficient and user-friendly presentation of information regarding the functionality of trusted device 110 and suspect device 120, respectively. GUIs 112 and/or 122 may comprise a plurality of displays having interactive fields, pull-down lists, and buttons operated by user 102. GUIs 112 and/or 122 may include multiple levels of abstraction including groups and boundaries. In certain embodiments, GUIs 112 and/or 122 may comprise a web browser. In another embodiment, GUIs 112 and/or 122 may comprise a graphical representation of a mobile application.

At certain times, trusted device 110 and/or suspect device 120 may attempt to communicate with authentication server 140 or access service 160 over network 130. Network 130 facilitates wireless or wireline communication. Network 130 may communicate, for example, IP packets, Frame Relay frames, Asynchronous Transfer Mode (ATM) cells, voice, video, data, and other suitable information between network addresses. Network 130 may include one or more personal area networks (PANs), local area networks (LANs), a wireless LAN (WLAN), a virtual private network (VPN), radio access networks (RANs), metropolitan area networks (MANs), wide area networks (WANs), mobile networks (e.g., using WiMax (802.16), WiFi (802.11), 3G, 4G, or any other suitable wireless technologies in any suitable combination), all or a portion of the global computer network known as the Internet, an extranet, a satellite network, and/or any other communication system or systems at one or more locations, any of which may be any suitable combination of wireless and wireline.

Generally, user 102 may use network 130 to access a service offered by an enterprise. For example, a financial institution may allow user 102 to conduct a financial transaction via a website using a computing device. These services may further include any suitable combination of computer services (e.g., storage, computer processing, networking, applications, power, or any other suitable computing resource that may be made available over a network), financial services (e.g., bank account access, withdrawals, deposits, transfers, balance inquires, or any other suitable financial service that may be available over a network), and/or retail services (e.g., purchase and/or sale of goods and services or any other suitable retail service that may be available over a network). In certain embodiments, one or more of those services may be provided by service 160. Service 160 may be any software, hardware, firmware, or combination thereof capable of providing user 102 with a service suitable for a particular purpose. For example, service 160a may be an online banking service and service 160b may be a data storage service.

Prior to gaining access to service 160, user 102 may be authenticated by authentication server 140. For example, in order to allow a customer to conduct a financial transaction, the enterprise may desire to authenticate the customer first, using authentication server 140. Authentication server 140 may receive information, such as user credentials (e.g., a username and password), and determine whether a particular customer's user credentials are valid. If the user credentials are valid, then authentication server 140 may confirm the customer as authorized and allow the customer to access the desired service 160.

In certain situations, user 102 may desire to access service 160 using suspect device 120 but does not desire to enter user credentials. In such situations, user 102 may use trusted device 110 to request temporary authentication token 111 from authentication server 140. Temporary authentication token 111 may be any information with an expiration date that may be used to authenticate user 102 once. User 102 can then enter this temporary authorization token (along with any other information that an enterprise may optionally require such as a token verifier) into GUI 122 of suspect device 120. Authentication server 140 may then allow user 102 to access service 160 using suspect device 120 without the need for entering user credentials into suspect device 120.

More specifically, authentication server 140 may comprise processor 142, memory 144, user accounts 146, trusted device data 148, authenticator module 150, token generator 152, and temporary authentication tokens 154. Processor 142 may include one or more microprocessors, controllers, or any other suitable computing devices or resources. Processor 142 may work, either alone or with components of suspect device authentication system 100, to provide a portion or all of the functionality of suspect device authentication system 100 described herein. For example, in some embodiments, processor 142 may provide functionality for authenticator module 150 and/or token generator 152. Processor 142 communicatively couples to memory 144. Memory 144 may take the form of volatile or non-volatile memory including, without limitation, magnetic media, optical media, RAM, ROM, removable media, or any other suitable memory component. In certain embodiments, a portion or all of memory 144 may store one or more database data structures, such as one or more structured query language (SQL) servers or relational databases. For example, the data of user accounts 146, trusted device data 148, and/or temporary authentication tokens 154 could be stored in memory 144 according to some embodiments.

In certain embodiments, memory 144 may be internal or external to processor 142 and may include one or more instruction caches or one or more data caches. Instructions in the instruction caches may be copies of instructions in memory 144, and the instruction caches may speed up retrieval of those instructions by processor 142. Data in the data caches may include any suitable combination of copies of data in memory 144 for instructions executing at processor 142 to operate on, the results of previous instructions executed at processor 142 for access by subsequent instructions executing at processor 142, or for writing to memory 144, and/or any other suitable data. The data caches may speed up read or write operations by processor 142.

Authentication server 140 may include user accounts 146. Generally, user accounts 146 contain information about users 102 that access or otherwise use services from the enterprise. In particular, each user account 146 may be associated with a certain user 102. User account 146 may contain information such as a unique customer identifier, customer name, user credentials, customer address, email address, token verification information, customer preferences, payment information, and/or any other information useful for monitoring and purchasing resources as appropriate. User credentials and/or token verification information may be one or more of a user's name, a username, a password, an account name, a personal identification number, a social security number, a credit card number, any combination thereof, or any other information that can be used to authenticate user 102. In certain embodiments, user accounts 146 may be stored in one or more text files, tables in a relational database, or any other suitable data structure capable of storing information.

Authentication server 140 may also include trusted device data 148. Trusted device data 148 may comprise information about one or more trusted devices 110. For example, trusted device data 148 may include information, for each trusted device 110, such as a unique device identifier, the type of device, and a reference to the particular user 102 that is associated with the particular trusted device 110. In certain embodiments, the reference to a particular user 102 that is associated with the particular trusted device 110 may be a reference to the particular user account 146 associated with the particular user 102. In certain embodiments, trusted device data 148 may be stored in one or more text files, tables in a relational database, or any other suitable data structure capable of storing information.

Authentication server 140 may facilitate the authentication of a particular user 102 using authenticator module 150. Generally, authenticator module 150 may determine whether information received by a particular user 102 matches information associated with the particular user 102. More specifically, authenticator module 150 may be any software, hardware, firmware, or combination thereof capable of authenticating user 102. For example, authenticator module 150 may be operable to receive a message from a device requesting to authenticate a particular user 102. Authenticator module 150 may use information included in the message to determine whether the device requesting authentication is a trusted device 110 associated with the particular user 102. In certain embodiments, authenticator module 150 may do this by comparing information included in the message with trusted device data 148.

As another example of authentication, authenticator module 150 may be operable to receive a message requesting to authenticate a particular user 102. The message may also include user credentials that authenticator module 150 may compare to stored user credentials associated with user 102 to determine whether to authenticate user 102. In certain embodiments, authenticator module 150 may receive user credentials in non-clear text format (e.g., in encrypted, hashed, and/or tokenized form) where one or more functions were performed on the user credentials before arriving at authenticator module 150. In such embodiments, authenticator module 150 may perform one or more functions to compare received user credentials to user credentials that may be stored in user accounts 146 to determine whether the user credentials match, resulting in the authentication of user 102.

Authenticator module 150 may also determine that a message requesting to authenticate user 102, received from trusted device 110 may include a request to communicate temporary authentication token 111 to trusted device 110. Temporary authentication token 111 may be used to authenticate user 102 using any supported device without having to enter user credentials. Authenticator module 150 is operable to facilitate the generation of temporary authentication token 111 by communicating a request to token generator 152. Token generator 152 may be any software, hardware, firmware, or combination thereof capable of generating temporary authentication token 111 that can be used to authenticate user 102. In certain embodiments, one or more temporary authentication token(s) 111 generated by token generator 152 may be stored in temporary authentication tokens 154. Temporary authentication tokens 154 may store any suitable information associated with generated temporary authentication tokens 111 such as a unique token identifier, a token label, an identifier for a particular user 102 associated with a particular generated temporary authentication token 111, an expiration time limit for using the particular temporary authentication token 111, and/or whether the particular temporary authentication token 111 has already been used by user 102.

In certain embodiments, authentication server 140 may be used by the enterprise to initiate authentication of a particular user 102. For example, a customer service agent of the enterprise may desire to verify user 102 by sending temporary authentication token 111 to trusted device 110. In such an embodiment, the customer service agent may facilitate generation of temporary authentication token 111 by instructing authenticator module 150 to initiate generation of temporary authentication token 111. Authenticator module 150 may initiate the generation of temporary authentication token 111 and subsequent communication of temporary authentication token 111 to trusted device 110. User 102 may then verbally read the received temporary authentication token 111 to the customer service agent, who can verify that the information read by user 102 matches the temporary authentication token 111 associated with user 102. In another scenario, user 102 may be prompted by a customer service agent to enter the received temporary authentication token 111 into any suitable device capable of displaying a graphical representation of a customer service application. User 102 may then enter temporary authentication token 111 into the suitable device and request authentication via authentication server 140. Once user 102 is authenticated, the customer service session may continue.

As a further example of authentication functionality that may be performed by authenticator module 150, authenticator module 150 may receive a message from suspect device 120 requesting to authenticate user 102. The message may include temporary authentication token 111 which authenticator module 150 may determine matches information associated with user 102. In certain embodiments, authenticator module 150 may determine whether the received temporary authentication token 111 matches a temporary authentication token 111 stored in temporary authentication tokens 154 that is associated with user 102.

Furthermore, authenticator module 150 may be operable to determine whether a particular temporary authentication token 111 is expired. For example, authenticator module 150 may determine time information indicating when the authentication attempt was initiated. Authenticator module 150 may then compare that information to expiration information associated with the particular temporary authentication token 111 stored in temporary authentication tokens 154. The expiration information may be a time threshold representing a point in time after which the particular temporary authentication token 111 may not be used to authenticate a user 102. The expiration threshold may be of varying lengths and in varying formats as suitable for particular purposes. The expiration threshold may be represented in absolute time or in relative time to a particular event (e.g., creation of the token, reception of the authentication attempt, etc.). If authentication module 150 determines that the particular temporary authentication token 111 is expired (i.e., is beyond the expiration threshold), then authentication of user 102 may be rejected.

Additionally, in certain embodiments, temporary authentication token 111 may be single use. For example, authentication module 150 may retrieve information regarding a particular temporary authentication token 111 from temporary authentication tokens 154 and determine whether the temporary authentication 111 has been used before to authenticate user 102. In certain embodiments, temporary authentication tokens 154 may associate a use flag that indicates whether a particular temporary authentication token 111 has been used. If authentication module 150 determines that the temporary authentication token 111 has previously been used, then the request to authenticate user 102 may be rejected. If user 102 is authenticated based on a particular temporary authentication token 111, then authenticator module 150 may change information regarding temporary authentication token 111 to indicate that the particular temporary authentication token 111 has been used to authenticate user 102. In some embodiments, this may be accomplished by changing a use flag associated with the particular temporary authentication token 111 stored in temporary authentication tokens 154.

For additional security, a token verifier may be used to authenticate a user 102 requesting authentication using temporary authentication token 111 according to some embodiments. A token verifier may be any information that may be associated with user 102 that is used to authenticate user 102 in addition to temporary authentication token 111. Some non-exhaustive examples of a token verifier are a user's name, a username, a password, an account name, a personal identification number, a social security number, a credit card number, a date of birth, or any other suitable information that may be used to authenticate a user 102. In certain embodiments, a token verifier may be unique from a user credential. In other embodiments, a token verifier may not be unique from a user credential.

The operation of suspect device authentication system 100 will now be discussed. Generally, user 102 may desire to access a particular service using suspect device 120. In certain authentication systems, one method for user 102 to access a service 160 using suspect device 120 is for user 102 to input various user credentials and other information into suspect device 120. However, there may be times when, for convenience and/or security reasons, user 102 does not wish to input various user credentials into suspect device 120. In such instances, user 102 may use trusted device 110 to send a token request to the enterprise. The enterprise may respond by sending temporary authentication token 111 to trusted device 110. After receiving temporary authentication token 111 on trusted device 110, user 102 may then enter this information into suspect device 120, giving user 102 access to a particular service 160.

More specifically, user 102 may use GUI 112 of trusted device 110 to send a request for temporary authentication token 111 to the enterprise. For example, in response to user 102 using GUI 112 to request temporary authentication token 111, trusted device 110 may communicate message 114 over network 130 to authentication server 140. Message 114 may comprise a request for temporary authentication token 111. In response to receiving message 114, authentication server 140 may begin to process the request for authentication by communicating the request for temporary authentication token 111 to authenticator module 150.

Authenticator module 150 may then determine whether the request for temporary authentication token 111 was received from a device associated with user 102. In certain embodiments, authenticator module 150 may do this by using device identifier information included in message 114 to determine whether the device generating message 114 is associated with user 102 in trusted device data 148. If authenticator module 150 determines that the requesting device is not a device associated with user 102, then authenticator module 150 may reject the request for temporary authentication token 111. On the other hand, if authenticator module 150 determines that the requesting device is a trusted device 110 associated with user 102, then authenticator module 150 may facilitate the generation of temporary authentication token 111.

To facilitate generation of temporary authentication token 111, authenticator module 150 may instruct token generator 152 to generate temporary authentication token 111. In some embodiments, in addition to generating temporary authentication token 111, information about the generated temporary authentication token 111 may be saved in temporary authentication tokens 154. After temporary authentication token 111 has been generated, authentication server 140 may communicate temporary authentication token 111 to trusted device 110 over network 130. Authentication server 140 may communicate this temporary authentication token via email, SMS text message, instant message, or any other suitable messaging format suitable for a particular purpose. According to some embodiments, temporary authentication token 111 may be communicated to trusted device 110 in message 114. Trusted device 110 may then receive temporary authentication token 111 and may display temporary authentication token 111 to user 102 via GUI 112.

After receiving temporary authentication token 111, user 102 may use temporary authentication token 111 to attempt to access a particular service 160 using suspect device 120. In particular, user 102 may retrieve temporary authentication token 111 and input it into suspect device 120 using GUI 122. In certain embodiments, user 102 may enter information in addition to temporary authentication token 111. For example, user 102 may enter account information and/or a token verifier. According to some embodiments, a token verifier may be a user credential. In other embodiments, a token verifier may be any information other than a user credential that authentication server 140 may use to verify user 102.

In response to user 102 inputting temporary authentication token 111 into GUI 122, and any other additional information, suspect device 120 may communicate message 116 over network 130 to authentication server 140. Message 116 may comprise a request to authenticate user 102 and may include temporary authentication token 111, as well as any additional information such as a token verifier.

Authentication server 140, in response to receiving message 116, may facilitate authentication of user 102 by instructing authenticator module 150 to process the information included in message 116. For example, authenticator module 150 may determine if the token verifier included in message 116 is correct. Authenticator module 150 may do this by determining whether the token verifier included in message 116 is associated with user 102. In certain embodiments, authenticator module 150 may retrieve information from user accounts 146 to determine whether the token verifier matches a token verifier associated with user 102.

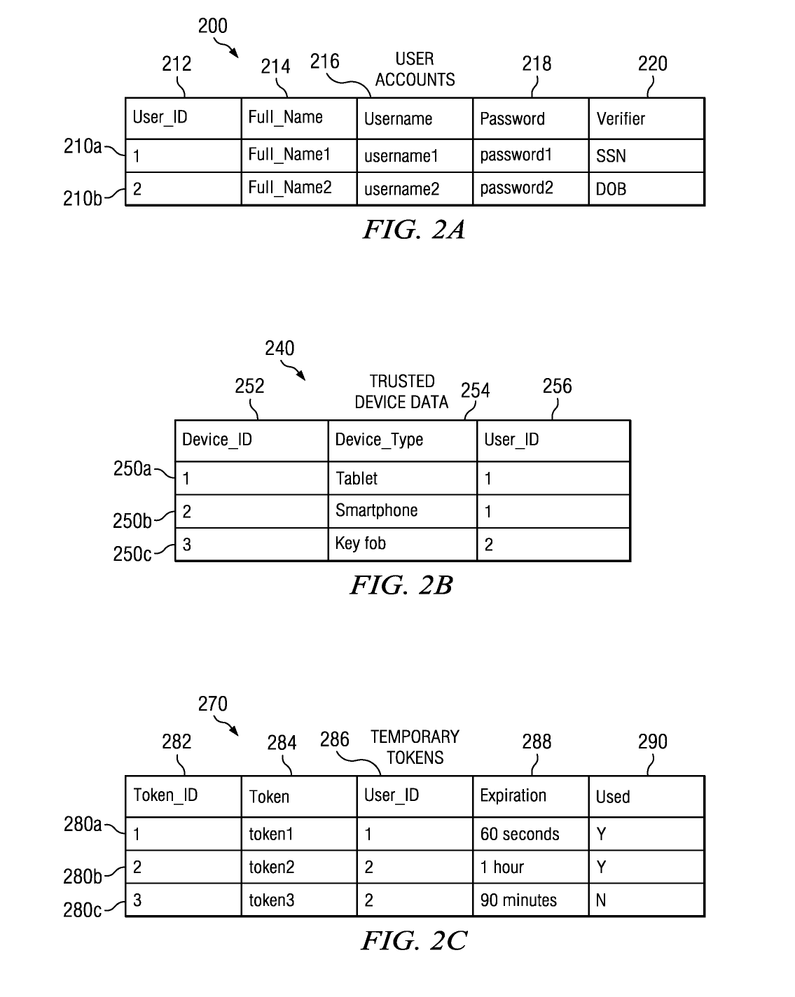

Authenticator module 150 may then determine whether the received temporary authentication token 111 is valid. In certain embodiments, authenticator module 150 may verify temporary authentication token 111 by retrieving information from temporary authentication tokens 154. Example information retrieved from temporary authentication tokens 154 may include a user identifier, expiration information, a use flag, a token identifier, information about the actual contents of temporary authentication token 111, and/or any other information suitable for an appropriate purpose. Example information that may be included in temporary authentication tokens 154 is further discussed below in the discussion of FIG. 2C. Using information retrieved from temporary authentication tokens 154, authenticator module 150 may determine if the received temporary authentication token 111 is associated with user 102. For example, authenticator module 150 may determine whether a user identifier associated with temporary authentication token 111 is also associated with user 102. If authenticator module 150 determines that the received temporary authentication token 111 is not associated with user 102, authenticator module 150 may reject the request for authentication of user 102.

Additionally, authenticator module 150 may use the retrieved information from temporary authentication tokens 154 to determine whether the received temporary authentication token 111 has expired. For example, authenticator module 150 may determine that the received temporary authentication token 111 has exceeded an expiration threshold, such as a time limit. If the received temporary authentication token 111 has exceeded an expiration threshold, then authenticator module 150 may reject a request to authenticate user 102. Furthermore, authenticator module 150 may determine if the received temporary authentication token 111 has previously been used using information retrieved from temporary authentication tokens 154. If the temporary authentication token 111 has been previously used, authenticator module 150 may reject the request to authenticate user 102. If, however, authenticator module 150 determines that information received in message 116 matches information in temporary authentication tokens 154 and user accounts 146, is not expired, and has not been previously used, authenticator module 150 may authenticate user 102.

In response to authenticating user 102, authenticator module 150 may communicate a message to the particular service user 102 was attempting to access instructing the particular service to grant access to user 102. For example, authenticator module 150 may communicate message 162 to service 160, message 162 instructing service 160 to grant access to user 102. In certain embodiments, user 102 may be attempting to access one of many services 160. For example, user 102 may be attempting to access service 160a. In such embodiments, authenticator module 150 may communicate message 162a to service 160a instructing service 160a to grant access to user 102. As another example, user 102 may attempt to access service 160b. In such an instance, authenticator module 150 may communicate message 162b to service 160b instructing service 160b to grant access to user 102. Furthermore, in response to authenticating user 102, authenticator module 150 may communicate message 116 to suspect device 120 informing user 102 that user 102 has been granted access to a particular service 160.

In certain instances, a request to authenticate user 102 may not be accompanied by temporary authentication token 111. For example, message 116 may be communicated by suspect device 120 over network 130 to authentication server 140. Message 116 may simply include user credentials. In response to receiving message 116, authenticator module 150 may then attempt to verify the user credentials included in message 116. Authenticator module 150 may do this by determining whether the user credentials included in message 116 match the user credentials associated with user 102. In certain embodiments, authenticator module 150 may do this by determining whether the user credentials received in message 116 match the user credentials associated with user 102 in user accounts 146. If authenticator module 150 determines that the user credentials do not match the user credentials associated with user 102, authenticator module 150 may reject the request for authentication of user 102. If authenticator module 150 determines that user credentials received in message 116 match user credentials associated with user 112, then authenticator module 150 may authenticate user 102. In response to authenticating user 102, authenticator module 150 may communicate message 162 to service 160 instructing service 160 to grant access to user 102.

Any component of suspect device authentication system 100 may include an interface (e.g., network interface), logic, memory, and other suitable elements. An interface receives input, sends output, processes the input and/or output and/or performs other suitable operations. An interface may comprise hardware and/or software. Logic performs the operation of the component, for example, logic executes instructions to generate output from input. Logic may include hardware, software, and/or other logic. Logic may be encoded in one or more non-transitory media, such as a computer-readable medium or any other suitable tangible medium, and may perform operations when executed by a computer. Certain logic, such as a processor, may manage the operation of a component. Examples of a processor include one or more computers, one or more microprocessors, one or more applications, and/or other logic. Any suitable logic may perform the functions of suspect device authentication system 100.

Certain embodiments of the present disclosure may provide some, none, or all of the following technical advantages. For example, security may be increased for a user because the user will not have to enter private user credentials into a public, unfamiliar, or otherwise suspect device. Through the use of a temporary authentication token, the user can ensure that a malicious party may not gain access to the user's private user credentials. Another advantage is added convenience to the user. By using a trusted device to request a temporary authentication token, the user will not have to remember the user's user credentials each time the user wants to access a service via a suspect device. Security is further enhanced by allowing the user to quickly obtain a temporary authentication token instead of perhaps memorializing user credentials on a physical item such as paper which may be lost or discarded and may be discovered by a third party.

FIG. 2A illustrates example user account data which may be used by the example system of FIG. 1. The example dataset of FIG. 2A is user accounts information 200. User accounts information 200 is information that may be used by authentication server 140 to provide various functionality to suspect device authentication system 100. In certain embodiments, user accounts information 200 may be stored as part of user accounts 146. It should be understood that user accounts information 200 is provided for example purposes only. User accounts information 200 is depicted as having a tabular structure for illustrative purposes only. User accounts information 200 can be stored in a text file, a table in a relational database, a spreadsheet, a hash table, a linked list, or any other suitable data structure capable of storing information. Moreover, the data relationships depicted are also for illustrative purposes only. For example, a particular ratio between data elements may be illustrated for example purposes only. Suspect device authentication system 100 is capable of handling data in any suitable format, volume, structure, and/or relationship as appropriate. In the illustrated example, records 210 are example entries of user accounts information 200 where each record 210 corresponds to a particular user 102.

User accounts information 200 may contain user identifier 212, full name 214, username 216, password 218, token verifier 220, and/or any other suitable information. In certain embodiments, user identifier 212 references a particular user account 146 associated with user 102. User identifier 212 may be a number, text string, or any other identifier capable of identifying a particular user account 146. In the current example, records 210a and 210b contain user account identifier 212 of “1” and “2” respectively, which may reference different user accounts 146 associated with different users 102.

Full name 214 may represent the full name of the user 102 associated with the particular user account 146. For example, record 210a may be associated with a user 102 having full name 214 of “Full_Name1.” Record 210b may be associated with a user 102 having full name 214 of “Full_Name2.”

User accounts information 200 may also include information about user credentials associated with a particular user 102. For example, in certain embodiments, user accounts information 200 may include username 216 and password 218. Username 216 may be any label that can indicate to suspect device authentication system 100 to which particular user 102 a particular user account 146 belongs. For example, suspect device authentication system 100 may use username 216 to determine which user 102 is requesting authentication. In the illustrated example, record 210a has a corresponding username 216 of “username1” and record 210b has a corresponding username 216 of “username2.”

User accounts information 200 may also include password 218. Password 218 may be any information that user 102 may input in a request for authentication that can be verified by suspect device authentication system 100. For example, in the illustrated example, record 210a has a corresponding password 218 of “password1” and record 210b has a corresponding password 218 of “password2.”

In certain embodiments, in order to authenticate a user using a temporary authentication token 111, an enterprise may also request a token verifier 220. Token verifier 220 may be any information that a particular user 102 may input in requests for authentication, in addition to a temporary authentication token 111, that can be verified by suspect device authentication system 100. For example, a token verifier 220 may be all or part of a social security number, all or part of a date of birth, all or part of a credit card number, a user's name, a user credential, a combination of one or more of the previous items, or any other information that may be used to verify a user 102 authentication attempt. In the illustrated example, record 210a has a token verifier 220 of “SSN” signifying a social security number. Record 210b has a token verifier 220 of “DOB” signifying a token verifier 220 of date of birth.

FIG. 2B illustrates example trusted device data which may be used by the example system of FIG. 1. Trusted device data 240 may be any data that is gathered by suspect device authentication system 100 about any trusted device 110. It should be understood that trusted device data 240 is provided for example purposes only. Trusted device data 240 is depicted as having a tabular structure for illustrative purposes only. Trusted device data 240 can be stored in a text file, a table in a relational database, a spreadsheet, a hash table, a linked list, or any other suitable data structure capable of storing information. Moreover, the data relationships depicted are also for illustrative purposes only. For example, a particular ratio between data elements may be illustrated for example purposes only. Suspect device authentication system 100 is capable of handling data in any suitable format, volume, structure, and/or relationship as required by particular needs. Trusted device data 240 may be example data that is included in trusted device data 148 of FIG. 1.

Trusted device data 240 may contain device identifier 252, device type 254, user identifier 256, and/or any other suitable information. In certain embodiments, device identifier 252 is a unique identifier that references a particular trusted device 110. Device 252 may be a number, a text string, or any other identifier capable of identifying a particular trusted device 110. In the current example, record 250a includes device identifier 252 of “1,” record 250b includes a device identifier 252 of “2,” and record 250c includes a device identifier 252 of “3.”

Trusted device data 240 may also include device type 254. Device type 254 may be any label that describes the classification of trusted device 110. For example, device type 254 may be a laptop computer, a personal digital assistant, a cellular phone, a tablet, a portable media player, a smart device, a smart phone, a key fob, or any other device capable of communication. In the illustrated example, record 250a has a corresponding device type 254 of “Tablet,” record 250b has a corresponding device type 254 of “Smartphone,” and record 250c has a corresponding device type 254 of “Key fob.”

Trusted device data 240 may also include user identifier 256 which may be a reference to a particular user account 146 associated with user 102. In certain embodiments, user identifier 256 may be a reference to user identifier 212 of FIG. 2A. User identifier 256 may be any number, text string, or any other identifier capable of identifying a particular user account 146. In the illustrated example, record 250a and record 250b both have user identifier 256 of “1.” This signifies that more than one trusted device 110 may be associated with a single user 102. Record 250c has a user identifier 256 of “2,” signifying that the user 102 associated with this particular trusted device 110 is different than the user 102 associated with the trusted devices 110 of records 250a and 250b.

FIG. 2C illustrates example temporary authentication token data which may be used by the example system of FIG. 1. The example dataset of FIG. 2C is temporary token information 270. Temporary token information 270 is information used by authentication server 140 to provide various authentication services and functionalities to suspect device authentication system 100. In certain embodiments, temporary token information 270 may be stored as part of temporary authentication tokens 154. It should be understood that temporary token information 270 is depicted as having a tabular structure for illustrative purposes only. Temporary token information 270 can be stored in a text file, a table in a relational database, a spreadsheet, a hash table, a linked list, or any other suitable data structure capable of storing information. Moreover, the data relationships depicted are also for illustrative purposes only. For example, a particular ratio between data elements may be illustrated for example purposes only. Suspect device authentication system 100 is capable of handling data in any suitable format, volume, structure, and/or relationship as appropriate. In the illustrated example, records 280 are example entries of temporary token information 270 where each record 280 corresponds to a particular token.

Temporary token information 270 may contain token identifier 282, token 284, user identifier 286, expiration 288, use flag 290, and/or any other suitable information. In certain embodiments, token identifier 282 is an identifier that references a particular temporary authentication token 111. Token identifier 282 may be a number, text string, or any other identifier capable of identifying a particular temporary authentication token 111. In the current example, record 280a has a token identifier 282 of “1,” record 280b has a token identifier 282 of “2,” and record 280c has a token identifier 282 of “3.” Temporary token information 270 may also include token 284. Token 284 may be the actual temporary authentication token 111 that a user 102 may enter into a suspect device 120 in order to be authenticated to use a particular service 160. Token 284 may be any text string, number, symbols, or any combination thereof, or any other suitable format that is capable of being entered by user 102 into suspect device 120. Although in the illustrated example token 284 is stored as clear text, token 284 may be stored in encrypted, hashed, or any other masked format suitable for increased security. In the illustrated example, record 280a has a token 284 of “token1,” 280b has a token 284 of “token2,” and record 280c has a token 284 of “token3.” Temporary token information 270 may also have a user identifier 286. User identifier 286 may be any information that references a particular user 102. In certain embodiments, user identifier 286 may be a reference to user identifier 212 of FIG. 2A. In the illustrated example, record 280a contains user identifier 286 of “1.” Records 280b and 280c include user identifiers 286 of “2” which may signify that the tokens 284 included in records 280b and 280c are associated with the same user 102.

Temporary token information 270 may also include token expiration 288. Token expiration 288 may be any information that indicates to authentication server 140 when a particular temporary authentication token 111 may expire. Token expiration 288 may be in absolute time or it may be relative to a particular time. An example of relative expiration thresholds for token expiration 288 may be time elapsed after the creation of a particular temporary authentication token 111 or time elapsed after receiving a particular authentication request or any other event at a particular time suitable for any particular purpose. In the illustrated example, records 280a, 280b, and 280c all include relative expiration thresholds in token expiration 288. For example, record 280a includes a token expiration 288 of “60 seconds,” record 280b includes a token expiration 288 of “1 hour,” and record 280c includes a token expiration 288 of “90 minutes.”

Temporary token information 270 may further include use flag 290. Use flag 290 may be any information capable of indicating to authentication server 140 that a particular temporary authentication token 111 has already been used. If a particular temporary authentication token 111 has already been used, then a user 102 attempting to authenticate using a previously used temporary authentication token 111 may not be granted access to a particular service 160. Use flag 290 may be any alphanumeric character or string or any other data format or type capable of informing authentication server 140 whether a particular temporary authentication token 111 has previously been used. For example, record 280a has a use flag 290 of “y” signifying that the particular temporary authentication token 111 associated with record 280a has previously been used by the particular user 102 associated with this particular temporary authentication token 111. Similarly, record 280b has a use flag 290 of “y” also signifying that the particular temporary authentication token 111 associated with record 280b has previously been used by user 102 associated with record 280b. Record 280c has a use flag 290 of “n” signifying that the particular temporary authentication token 111 associated with record 280c has not yet been used to authenticate the particular user 102 associated with record 280c.

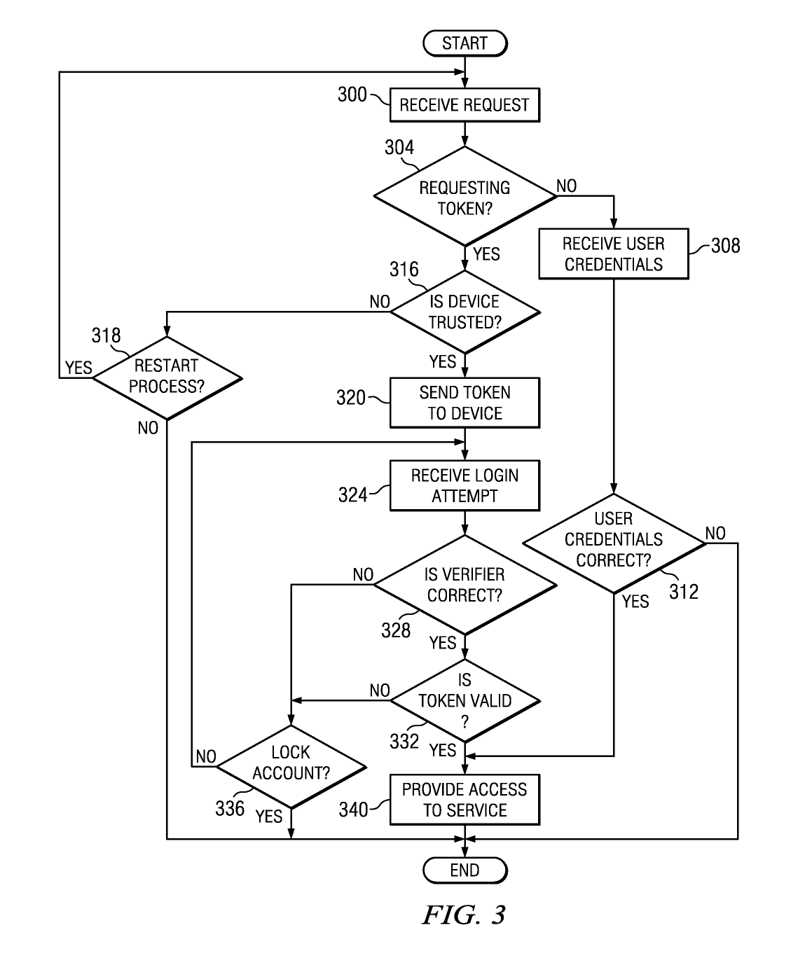

FIG. 3 illustrates an example method for authentication, which may be performed by the example system of FIG. 1 to authenticate a user, according to certain embodiments of the present disclosure. The example method of FIG. 3 may be performed by the example suspect device authentication system 100 of FIG. 1 according to certain embodiments of the present disclosure. The method may be implemented in any suitable combination of software, firmware, and hardware. Although particular components may be identified as performing particular steps, the present disclosure contemplates any suitable components performing the steps according to a particular purpose.

At step 300, user 102 may use a GUI of a device 110 to send a request for temporary authentication token 111 to the enterprise. For example, in response to user 102 using GUI 112 to request temporary authentication token 111, trusted device 110 may communicate message 114 over network 130 which is received by authentication server 140. As another example, user 102 may simply elect to use user credentials for authentication using GUI 122 of suspect device 120, which then communicates message 116 over network 130 to authentication server 140. At step 304, authentication server 140 may determine whether the received message comprises a request for temporary authentication token 111. If the message comprises a request for temporary authentication token 111, then the example method may proceed to step 316. Otherwise, the example method may proceed to step 308.

At step 308, authenticator module 150 may extract user credentials from message 116 and proceed to step 312. At step 312, in response to receiving message 116 containing user credentials, authenticator module 150 may attempt to verify the user credentials included in message 116. Authenticator module 150 may do this by determining whether the user credentials included in message 116 match the user credentials associated with user 102. In certain embodiments, authenticator module 150 may do this by determining whether the user credentials received in message 116 match the user credentials associated with user 102 in user accounts 146. If authenticator module 150 determines that the user credentials do not match the user credentials associated with user 102, authenticator module 150 may reject the request for authentication of user 102 and the example method may end. If authenticator module 150 determines that user credentials received in message 116 match user credentials associated with user 112, then authenticator module 150 may authenticate user 102 and proceed to step 340.

At step 316, authenticator module 150 may determine whether the request for temporary authentication token 111 was received from a device associated with user 102. In certain embodiments, authenticator module 150 may do this by using device identifier information included in message 114 to determine whether the device generating message 114 is associated with user 102 in trusted device data 148. If authenticator module 150 determines that the requesting device is not a device associated with user 102, then authenticator module 150 may reject the request for temporary authentication token 111 and the example method may proceed to step 318. On the other hand, if authenticator module 150 determines that the requesting device is a trusted device 110 associated with user 102, then authenticator module 150 may advance to step 320.

At step 318, authentication server 140 may determine if user 102 desires to restart the authentication process. For example, authentication server 140 may communicate a message (e.g., message 114 or any other suitable message) to user 102 notifying user 102 that the authentication attempt has failed. Authentication server 140 may communicate such a message to the device user 102 used to request temporary authentication token 111, trusted device 112, and/or any other device capable of requesting temporary authentication token 111. The message may also initiate a prompt asking user 102 whether user 102 desires to restart the authentication process. If user 102 indicates a desire to reattempt authentication, then the example method may proceed to step 300. Otherwise, the example method may end.

At step 320, to facilitate generation of temporary authentication token 111, authenticator module 150 may instruct token generator 152 to generate temporary authentication token 111. In some embodiments, in addition to generating the particular temporary authentication token 111, information about the generated temporary authentication token 111 may be saved in temporary authentication tokens 154. After temporary authentication token 111 has been generated, authentication server 140 may communicate temporary authentication token 111 to trusted device 110 over network 130. Authentication server 140 may communicate this temporary authentication token 111 via email, SMS text message, instant message, or any other suitable messaging format suitable for a particular purpose. Trusted device 110 may then receive temporary authentication token 111 and may display temporary authentication token 111 to user 102 via GUI 112. The example method may then proceed to step 324.

At step 324, after receiving temporary authentication token 111, user 102 may use the temporary authentication token information received at trusted device 110 to attempt to access a particular service 160 using suspect device 120. For example, user 102 may attempt to log into a particular web service. In particular, user 102 may retrieve temporary authentication token 111 and input it into suspect device 120 using GUI 122. In certain embodiments, user 102 may enter information in addition to temporary authentication token 111. For example, user 102 may enter account information and/or a token verifier. According to some embodiments, a token verifier may be a user credential. In other embodiments, a token verifier may be any information other than a user credential that authentication server 140 may use to verify user 102. In response to user 102 inputting temporary authentication token 111 into GUI 122, and any other additional information, suspect device 120 may communicate message 116 over network 130 to authentication server 140. Message 116, which is received by authentication server 140, may comprise a request to authenticate user 102 and may include temporary authentication token 111, as well as any additional information such as a token verifier. The example method then advances to step 328.

At step 328, authentication server 140, in response to receiving message 116, may facilitate authentication of user 102 by instructing authenticator module 150 to process the information included in message 116. For example, authenticator module 150 may determine if the token verifier included in message 116 is correct. Authenticator module 150 may do this by determining whether the token verifier included in message 116 is associated with user 102. In certain embodiments, authenticator module 150 may retrieve information from user accounts 146 to determine whether the token verifier matches a token verifier associated with user 102. If the token verifier is not correct, the example method may proceed to step 336. Otherwise, the example method may continue to step 332.

At step 332, authenticator module 150 may determine whether the received temporary authentication token 111 is valid. In certain embodiments, authenticator module 150 may verify temporary authentication token 111 by retrieving information from temporary authentication tokens 154. Using information retrieved from temporary authentication tokens 154, authenticator module 150 may determine if the received temporary authentication token 111 is associated with user 102. If authenticator module 150 determines that the received temporary authentication token 111 is not associated with user 102, authenticator module 150 may reject the request for authentication of user 102 and the example method may proceed to step 336.

Additionally, authenticator module 150 may use the retrieved information from temporary authentication tokens 154 to determine whether the received temporary authentication token 111 has expired. For example, authenticator module 150 may determine that the received temporary authentication token 111 has exceeded an expiration threshold, such as a time limit. If temporary authentication token 111 has exceeded an expiration threshold, then authenticator module 150 may reject a request to authenticate user 102 and the example method may proceed to step 336.

Furthermore, authenticator module 150 may determine if the received temporary authentication token 111 has previously been used using information retrieved from temporary authentication tokens 154. If temporary authentication token 111 has been previously used, authenticator module 150 may reject the request to authenticate user 102, then the example method may proceed to step 336. If, however, authenticator module 150 determines that information received in message 116 matches information in temporary authentication tokens 154 and user accounts 146, is not expired, and has not been previously used, authenticator module 150 may authenticate user 102 and continue to step 340.

At step 336, authenticator module 150 may determine whether too many requests for authentication received by a particular user 102 were rejected. In certain embodiments, there may be a threshold number of rejections within a certain time period, which if exceeded, the account of user 102 may be locked, and a notification message may be sent to user 102 informing them of a possible malicious login attempt and the example method may end. If, however, the number of authentication rejections has not exceeded a threshold, then the example method may return to step 324.

At step 340, in response to authenticating user 102, authenticator module 150 may communicate a message to the particular service user 102 was attempting to access, instructing the particular service to grant access to user 102. For example, authenticator module 150 may communicate message 162 to service 160, message 162 instructing service 160 to grant access to user 102. In certain embodiments, user 102 may be attempting to access one of many services 160. For example, user 102 may be attempting to access service 160a. In such embodiments, authenticator module 150 may communicate message 162a to service 160a instructing service 160a to grant access to user 102. As another example, user 102 may attempt to access service 160b. In such an instance, authenticator module 150 may communicate message 162b to service 160b instructing service 160b to grant access to user 102. Furthermore, in response to authenticating user 102, authenticator module 150 may communicate message 116 to suspect device 120 informing user 102 that user 102 has been granted access to a particular service 160.

Although the present disclosure describes or illustrates particular operations as occurring in a particular order, the present disclosure contemplates any suitable operations occurring in any suitable order. Moreover, the present disclosure contemplates any suitable operations being repeated one or more times in any suitable order. Although the present disclosure describes or illustrates particular operations as occurring in sequence, the present disclosure contemplates any suitable operations occurring at substantially the same time, where appropriate. Any suitable operation or sequence of operations described or illustrated herein may be interrupted, suspended, or otherwise controlled by another process, such as an operating system or kernel, where appropriate. The acts can operate in an operating system environment or as stand-alone routines occupying all or a substantial part of the system processing.

Although the present disclosure has been described with several embodiments, diverse changes, substitutions, variations, alterations, and modifications may be suggested to one skilled in the art, and it is intended that the disclosure encompass all such changes, substitutions, variations, alterations, and modifications as falling within the spirit and scope of the appended claims.

1. A system comprising:
a memory operable to store a user account associated with a user; and
a processor communicatively coupled to the memory, the processor configured to:
receive a first notification associated with a first device;
determine whether the first device is associated with the user account;
reject authentication of the user in response to determining that the first device is not associated with the user account;
communicate a token to the first device in response to determining that the first device is associated with the user account;
receive a second notification associated with a second device, the second notification comprising a request to authenticate the user, wherein the user is attempting to access a service using a network;
determine an expiration threshold associated with the token;
determine time information associated with the second notification;
determine if the second notification comprises the token;
determine if the second notification comprises a verifier;
authenticate the user if:
the time information does not exceed the expiration threshold;
the second notification comprises the token; and
the verifier is associated with the user account;
determine if the second device is associated with the user account; and
authenticate the user if the second device is determined to be not associated with the user account and the second notification comprises user credentials associated with the user account.

2. A system comprising:
a memory operable to store a user account associated with a user; and
a processor communicatively coupled to the memory, the processor configured to:
receive a first notification associated with a first device;
determine whether the first device is associated with the user account;
reject authentication of the user in response to determining that the first device is not associated with the user account;
communicate a token to the first device in response to determining that the first device is associated with the user account;
receive a second notification associated with a second device, the second notification comprising a request to authenticate the user;
authenticate the user if the second notification comprises the token;
determine if the second device is associated with the user account;
authenticate the user if the second device is determined to be not associated with the user account and the second notification comprises user credentials associated with the user account.

3. The system of claim 2, wherein the processor is further configured to:
receive a third notification, wherein the third notification comprises the token and a second request to authenticate the user;
determine if the user was authenticated, prior to receiving the third notification, based at least in part upon the token; and
reject authentication of the user in response to determining that the user was authenticated, prior to receiving the third notification, based at least in part upon the token.

4. The system of claim 2, wherein authenticating the user if the second notification comprises the token comprises:
determining expiration threshold associated with the token;
determining time information associated with the second notification; and
authenticating the user based at least in part upon the expiration threshold associated with the token and the time information associated with the notification.

5. The system of claim 4, wherein authenticating the user based at least in part upon the expiration information associated with the token and the time information associated with the notification comprises:
determining whether the time information exceeds the expiration threshold;
rejecting authentication of the user in response to determining that the time information exceeds the expiration threshold.

6. The system of claim 2, wherein the processor is further configured to associate the token with the user account.

7. The system of claim 2, wherein the second notification comprises an indication that the user is attempting to access a service.

8. The system of claim 7, wherein the user is attempting to access the service using a network.

9. The system of claim 7, wherein authenticating the user comprises allowing the user to access the service.

10. The system of claim 2, wherein the first device is a selected one of the following:
a smart phone;
a tablet device;
a cellular device;
a personal computer; or
a key fob.

11. The system of claim 2, wherein the second notification comprises a verifier and authenticating the user if the second notification comprises the token comprises:
determining if the verifier is associated with the user account.

12. The system of claim 2, wherein the processor is further operable to authenticate the user if the second device is associated with the user account.

13. A method comprising:
storing, using a processor, a user account associated with a user;
receiving a first notification associated with a first device;
determining, using the processor, whether the first device is associated with the user account;
rejecting, using the processor, authentication of the user in response to determining that the first device is not associated with the user account;
communicating, using the processor, a token to the first device in response to determining that the first device is associated with the user account;
receiving a second notification associated with a second device, the second notification comprising a request to authenticate the user;
determining, using the processor, whether the second device is associated with the user account;
authenticating the user if the second notification comprises the token; and
authenticating the user if the second device is determined to be not associated with the user account and the second notification comprises user credentials associated with the user account.

14. The method of claim 13 further comprising:
receiving a third notification, wherein the third notification comprises the token and a second request to authenticate the user;
determining if the user was authenticated, prior to receiving the third notification, based at least in part upon the token; and
rejecting authentication of the user in response to determining that the user was authenticated, prior to receiving the third notification, based at least in part upon the token.

15. The method of claim 13, wherein authenticating the user if the second notification comprises the token comprises:
determining an expiration threshold associated with the token;
determining time information associated with the second notification; and
authenticating the user based at least in part upon the expiration threshold associated with the token and the time information associated with the notification.

16. The method of claim 15, wherein authenticating the user based at least in part upon the expiration information associated with the token and the time information associated with the notification comprises:
determining whether the time information exceeds the expiration threshold;
rejecting authentication of the user in response to determining that the time information exceeds the expiration threshold.

17. The method of claim 13 further comprising associating the token with the user account.

18. The method of claim 13, wherein the second notification comprises an indication that the user is attempting to access a service.

19. The method of claim 18, wherein the user is attempting to access the service using a network.

20. The method of claim 15, wherein authenticating the user comprises allowing the user to access the service.

21. The method of claim 13, wherein the first device is a selected one of the following:
a smart, phone;
a tablet device;
a cellular device;
a personal computer; or
a key fob.

22. The method of claim 13, wherein the second notification comprises a verifier and authenticating the user if the second notification comprises the token comprises:
determining if the verifier is associated with the user account.

23. The method of claim 13 further comprising authenticating the user if the second device is associated with the user account.
